(19) United States
(12) Patent Application Publication
(10) Pub. No.: US 2014/0003756 A1
(43) Pub. Date: Jan. 2, 2014

(54) ROLLING BEARING

(71) Applicant: Chang-Hsin KUO, Taichung City (TW)

(72) Inventor: Chang-Hsin KUO, Taichung City (TW)

(21) Appl. No.: 13/538,454

(22) Filed: Jun. 29, 2012

(51) Int. Cl. F16C 43/04

(52) U.S. Cl. 384/542; 384/584

(57) ABSTRACT

This invention is related to a rolling bearing, comprising a ring member, having a first rolling groove; two semi-ring members, each includes a first side and a second side, a slanted surface formed on said first side, and counter-bore and threaded holes disposed alternatively on said second side. Said first side of semi-ring member is in contact with said slanted surface thereof together form a second rolling groove. Said second rolling groove and said first rolling groove together form a rolling space. Said counter-bore holes on one semi-ring member being respectively connected to said threaded holes on another semi-ring member. Fasteners are arranged within said counter-bore and threaded holes to attach said semi-ring members. Therefore, the assembly of the bearing requires only two identical semi-ring members, and as the two semi-ring members are of an identical structure, the structure of the rolling bearing is symmetrical.

### BACKGROUND OF THE INVENTION

1. Technical Field

The present invention relates to a bearing structure, and more particularly, to a rolling bearing.

2. Description of Related Art

Bearings are common rotational components in mechanics and they are responsible to ensure rotational components to rotate smoothly while providing adequate support thereto, which are the main purposes of the bearings. Considering the assembly of current rolling bearings, in order to fill a bearing with the rolling elements therein (either balls or rollers), either one of the inner ring or outer ring of the bearing needs to be cut into two pieces, forming two semi-inner rings or two semi-outer rings. To assemble such a bearing, the inner ring and one of the semi-outer rings (or outer ring and one of the semi-inner rings) are assembled together, such that the rolling elements are filled into a rolling groove, followed by sealing the opening for filling rolling elements. Then, in order to affix the two semi-outer rings (or semi-inner rings), assembly holes are provided on the two semi-outer rings (or semi-inner rings) such that the screw threads can be used to fasten the two semi-outer rings (or semi-inner rings). However, the current fastening method to attach the two semi-outer rings mostly adapts the way of having the screw being fastened from one side to the other side, as disclosed in Japanese Patent Publication No. 2003-4050A, Japanese Patent Publication No. JP2009-291668A and Japanese Patent Publication No. JP2000-161366A. In such fastening methods, as the assembly screws are being fastened from one side to the other, one of the two semi-outer rings (or semi-inner rings) is required to receive all the screw heads, which leads to have only counter-bore holes disposed thereon, and the other semi-outer ring shows no need to receive screws heads but is only disposed of threaded holes. Such arrangements of the counter-bore holes and threaded holes can cause the two semi-outer rings (or semi-inner rings) to have no alternativeness between each other, which also causes the component stock and material stock to increase in folds, creating greater management risks in terms of commercial and economic aspects in today's harsh business environment. Furthermore, as the diameter of counter-bore holes is much greater than that of the threaded holes, the semi-outer ring (or semi-inner ring) that only has counter-bore holes is removed more material than the semi-outer ring (or semi-inner ring) that only has threaded holes, which causes its mechanical strength weaker. Especially, the semi-outer ring (or semi-inner ring) that only has counter-bore holes under forced or after heat treatment is much easier to be deformed by external forces. In addition, as the types of all holes on the two semi-outer rings (or semi-inner rings) are different, the physical properties including such as structure and mass are different. The asymmetry of the structural masses of the two semi-outer rings (or semi-inner rings) can cause a concern in the design of precision of mechanical devices. Therefore, although known rolling bearings have been used for years, these rolling bearings are yet to be improved.

### BRIEF SUMMARY OF THE INVENTION

An objective of the present invention is to provide a rolling bearing, requiring the use of identical semi-rings only to complete the assembly process of the bearing for the same type of bearing assembly process, such that the effect of having reduced component stock and material stock can be achieved.

A second objective of the present invention is to provide a rolling bearing, which has two identical semi-rings to prevent different quality of manufacturing bearings from different deformation of two semi-rings.

A third objective of the present invention is to provide a rolling bearing, wherein the structure and mass of the two semi-rings are identical to cease concern of the asymmetry of the structural mass of the two semi-rings in precision mechanical devices.

In view of the above, to achieve the abovementioned objectives, according to a rolling bearing of the present invention, comprising a ring member, having a first rolling groove; two semi-ring members, each one of said semi-ring members has a first side and a second side opposing to said first side, said first side of each one of said semi-ring members has a slanted surface, and a plurality of counter-bore holes and a plurality of threaded holes disposed on said second side of each one of said semi-ring members; said each one of said first sides of said semi-ring members being in contact with each other and each one of said slanted surfaces thereof together form a second rolling groove; said second rolling groove and said first rolling groove together form a rolling space; furthermore, each one of said counter-bore holes on one of said two semi-ring members being respectively connected to each one of said threaded holes on another one of said two semi-ring members; a plurality of rolling members, received within said rolling space; and a plurality of fasteners, arranged within each of one of said counter-bore holes and within each one of said threaded holes respectively to attach each one of said semi-ring members with threads.

Therefore, people use two identical semi-ring members to complete the bearing assembly without using different semi-ring members, which reduces component stock and material stock, and prevents different quality of manufacturing bearings from different deformation of two semi-rings different, and eliminates the problem associated with the asymmetry of the structural mass of the two semi-outer rings (or semi-inner rings) in precision mechanical devices.

### BRIEF DESCRIPTION OF THE SEVERAL VIEWS OF THE DRAWINGS

FIG. 1 is a perspective view of a first preferred embodiment of the present invention;

FIG. 2 is an illustration of a cross sectional view taken along the cross-section 2-2 of the first preferred embodiment of the present invention;

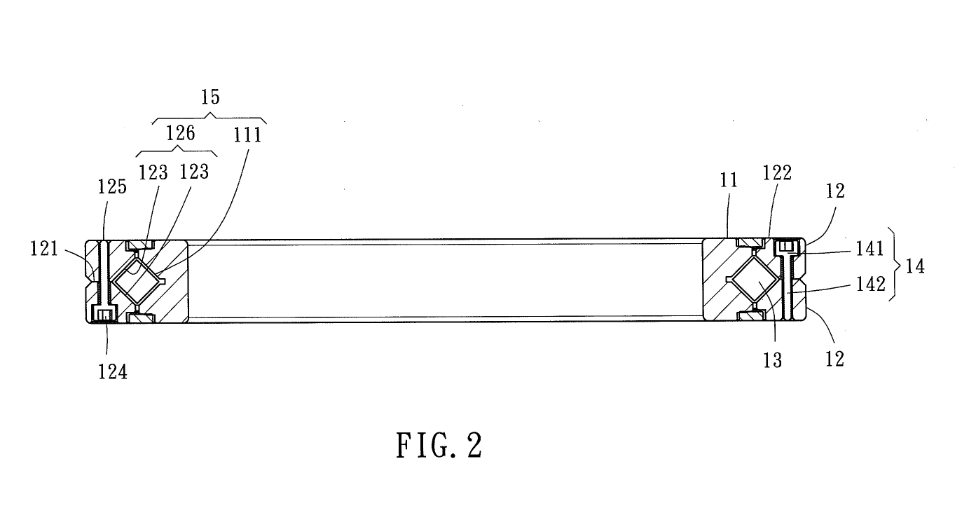

FIG. 3 is an exploded view of the first preferred embodiment of the present invention;

FIG. 4 is a perspective view of a second preferred embodiment of the present invention; and

FIG. 5 is a perspective view of a third preferred embodiment of the present invention.

### DETAILED DESCRIPTION OF THE INVENTION

In order to describe the technical features of the present invention in detail, the preferred embodiments along with the accompanied drawings are provided in the following.

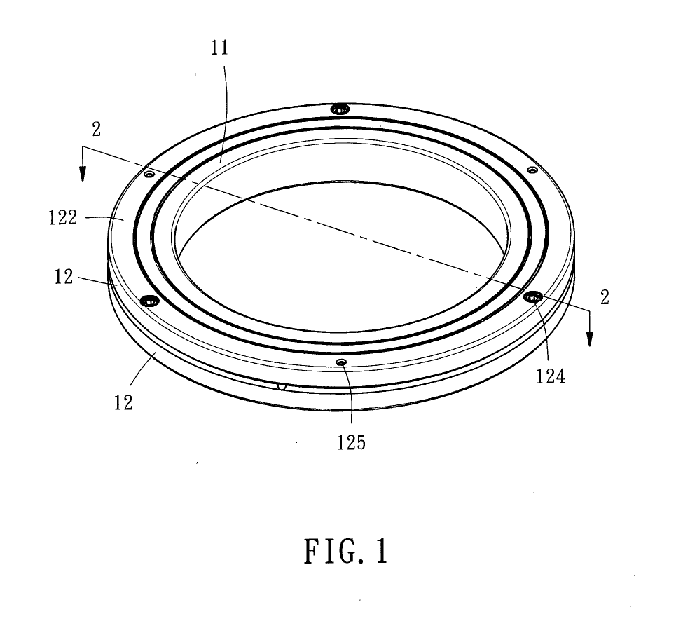

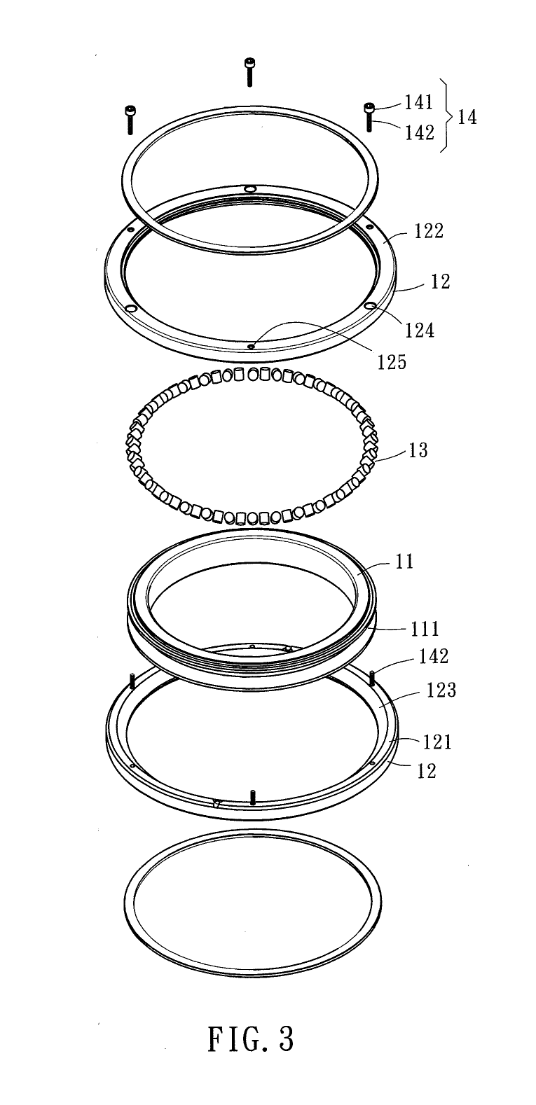

As shown in FIG. 1˜FIG. 3, a first embodiment of the present invention provides a rolling bearing mainly comprises a ring member 11, two semi-ring members 12, a plurality of rolling members 13 and a plurality of fasteners 14.

The ring member 11 is arranged within an inner side (i.e. inner ring) of the bearing and includes a first rolling groove 111.

Each one of said semi-ring members 12 is arranged at an outer side (i.e. outer semi-ring) and includes a first side 121 and a second side 122 opposing to said first side 121. Said first side 121 of each one of said semi-ring members 12 has a slanted surface 123, and said second side 122 of each one of said semi-ring members 12 is disposed of a plurality of counter-bore holes 124 and a plurality of threaded holes 125. Said plurality of counter-bore holes 124 and plurality of threaded holes 125 are disposed on the second side 122 of each one of said semi-rings.

The first sides 121 of each one of said semi-ring members 12 are in contact with each other after the assembly of the bearing, and each one of said slanted surfaces 123 together form a second rolling groove 126. The second rolling groove 126 and the first rolling groove 111 together form a rolling space 15. Furthermore, each one of said counter-bore holes 124 on one of said two semi-ring members 12 being respectively connected to each one of said threaded holes 125 on another one of said two semi-ring members 12.

Each one of said rolling members 13 are received within the rolling space 15. In a common practice, the rolling members 13 are balls or rollers. In this preferred embodiment, they are rollers.

In this preferred embodiment, each one of said fasteners 14 is a screw. In this embodiment, the fastener 14 is one with a screw head, having a screw head portion 141 configured on one end and a threaded portion 142 on the other end. Each one of the screw head portions 141 is fitted into each one of the counter-bore holes 124 and pressed against each one of the semi-ring members 12 respectively, and each one of the threaded portions 142 is fastened to each one of the threaded holes 125 of each one of the semi-ring members 12 with threads.

To further describe the present invention, in this preferred embodiment, said counter-bore holes 124 and said threaded holes 125 are of an identical number of holes. Certainly, the number of said counter-bore holes 124 and said threaded holes 125 can to be different. However, an excess of the counter-bore holes 124 and threaded holes 125 can have their downside effects on the strength of the semi-ring members 12.

Furthermore, in this preferred embodiment, each one of said counter-bore holes 124 and each one of said threaded holes 125 are alternatively disposed on said semi-ring members 12. The term “alternatively disposed” refers to the arrangement of each one of the counter-bore holes 124 and each one of the threaded holes 125 on the identical semi-ring members 12 in accordance with . . . counter-bore hole-threaded hole-counter bore hole-threaded hole . . . as the way of arrangement.

Furthermore, in this preferred embodiment, each one of said counter-bore holes 124 and each one of said threaded holes 125 are alternatively disposed on said semi-ring members 12 with an equal distance apart from each other. The term “equal distance apart from” refers to the configuration that each one of the counter-bore holes 124 and threaded holes 125 are of identical circular diameter and each one of the counter-bore holes 124 and the threaded holes 125 are of the same distance apart from each other.

The method of assembly of the first preferred embodiment of the present invention is as follows. First, the ring member 11 is positioned, and then one of the semi-ring members 12 is fitted onto the ring member 11, which is followed by the filling of the rolling members 13. The other semi-ring member 12 is then fitted onto the ring member 11 such that each one of the counter-bore holes 124 is connected to each one of the threaded holes 125. Then, each one of the fasteners 14 is fastened into each one of the counter-bore holes 124 and each one of the threaded holes 125 to attach each one of the semi-ring members 12 with threads.

It is worthwhile to point out that each one of said counter-bore holes 124 and each one of said threaded holes 125 are alternatively disposed on each one of said semi-ring members 12 with an equal distance apart from each other. If N refers to the total number of holes of the counter-bore holes 124 together with the threaded holes 125, each one of the counter-bore holes 124 can be positioned to corresponding meet with or connect to each one of the threaded holes 125 once one of the semi-ring members 12 is flipped and turned by an angle of 360/N degree.

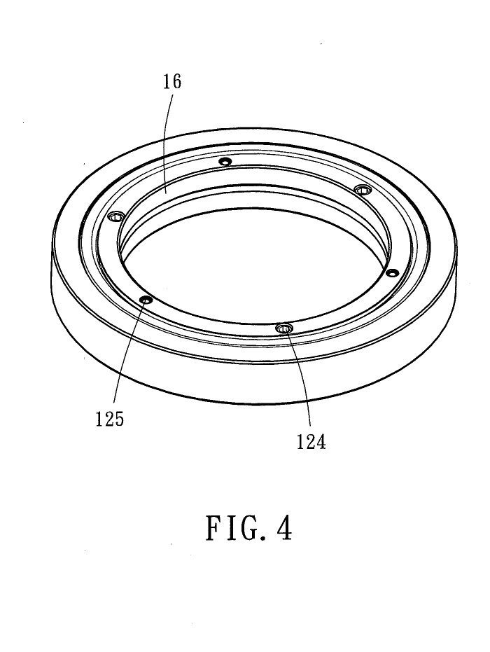

FIG. 4 shows a second preferred embodiment of the present invention. It differs from the first embodiment in that the first embodiment dissects the outer ring into two semi-ring members 12, whereas the second embodiment dissects the inner ring into two semi-ring members 16.

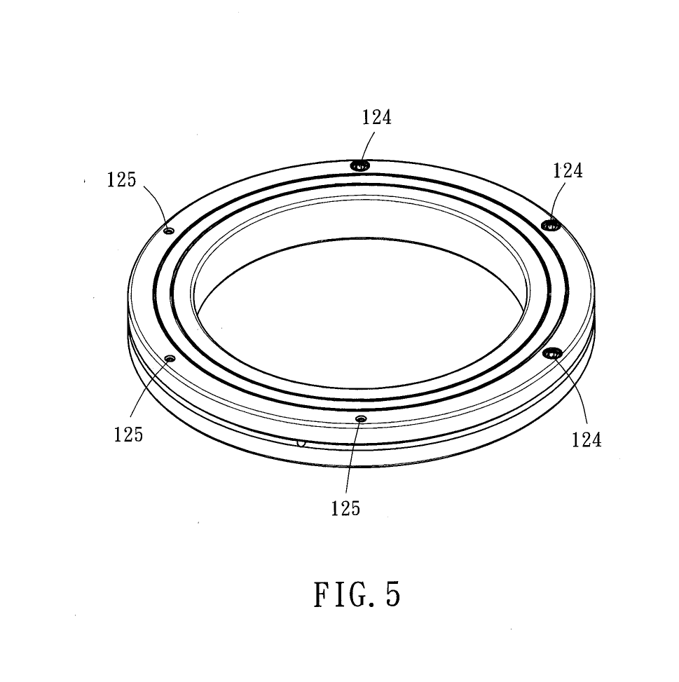

FIG. 5 shows a third preferred embodiment of the present invention. It differs from the first embodiment in that each one of the counter-bore holes 124 and each one of the threaded holes 125 are symmetrically disposed on the semi-ring members 12. By gathering each counter-bore holes 124 in one area, the fastening of the fasteners 14 is facilitated. However, if N refers to the total number of holes of the counter-bore holes 124 together with the threaded holes 125, each one of the counter-bore holes 124 can only be positioned to corresponding meet or connect to each one of the threaded holes 125 by flipping and turning one of the semi-ring members 12 at 180 degree rather than at a degree of 360/N. The method of assembly and other parts of the elements of this preferred embodiment are identical to ones of the first embodiment; therefore, details thereof are omitted.

Nevertheless, if one wishes to have each one of the semi-ring members 12 being subject to forces uniformly, it is preferably to configure each one of the counter-bore holes 124 and each one of the threaded holes 125 to be disposed on the semi-ring members 12 with a equal distance apart from each other; in other words, the first and second preferred embodiments are of greater preferences to achieve such effect.

In view of the abovementioned first, second and third preferred embodiments, only two identical semi-ring members 12 (or 16) are required to complete the assembly of a bearing. In contrast to the known technique requiring different semi-rings to achieve the assembly of bearings, the present invention can effectively achieve the effects of reducing the component stock and material stock. Especially for the first and second embodiments, as the counter-bore holes 124 and each one of the threaded holes 125 disposed on the semi-ring members 12 or semi-ring members 16 are of equal distance apart from each other, allowing the two semi-ring members to have an identical structure, which prevents deformation due to structural differences affecting the manufacturing quality thereby. As the structure and mass of the semi-ring members 12 or semi-ring members 16 of the present invention are identical, the problem associated with the asymmetry of structural masses in precision of mechanical devices is eliminated.

1. A rolling bearing, comprising:
a ring member, having a first rolling groove;
two semi-ring members, each one of said semi-ring members includes a first side and a second side opposing said first side, said first side of each one of said semi-ring members has a slanted surface, and a plurality of counter-bore holes and a plurality of threaded holes disposed on said second side of each one of said semi-ring members; said each one of said first sides of said semi-ring members being in contact with each other and each one of said slanted surfaces thereof together form a second rolling groove; said second rolling groove and said first rolling groove together form a rolling space; each one of said counter-bore holes on one of said two semi-ring members being respectively connected to each one of said threaded holes on another one of said two semi-ring members;
a plurality of rolling members, received within said rolling space; and
a plurality of fasteners, arranged within each of one of said counter-bore holes and within each one of said threaded holes respectively to attach each one of said semi-ring members with threads.

2. The rolling bearing as claimed in claim 1, wherein said counter-bore holes and said threaded holes are of an identical number at the second side of each said semi-ring member.

3. The rolling bearing as claimed in claim 1, wherein each one of said Counter-bore holes and each one of said threaded holes are alternatively disposed at the second side of each said semi-ring member.

4. The rolling bearing as claimed in claim 1, wherein each one of said counter-bore holes and each one of said threaded holes are alternatively disposed at the second side of each said semi-ring member at an equal interval.

5. The rolling bearing as claimed in claim 1, wherein said rolling members are balls or rollers,

6. (canceled)

7. The rolling bearing as claimed in claim 1, wherein each of one of said counter-bore holes is symetrically arranged with each one of said threaded holes the second side of each said semi-ring member at an equal interval.

8. The rolling bearing of claim 1, wherein each one of said counter-bore holes on one of said two semi-ring members is respectively directly connected to each one of said threaded holes on another one of said two semi-ring members.
